(19) United States
(12) Patent Application Publication
(10) Pub. No.: US 2018/0113956 A1
(43) Pub. Date: Apr. 26, 2018

(54) METHOD FOR DATA CAPTURE USING A DATA CAPTURE SYSTEM, AND DATA CAPTURE SYSTEM

(71) Applicant: Testo SE & Co. KGaA, Lenzkirch (DE)

(72) Inventors: Markus Munzer, Hufingen (DE); Jens Schaumann, Villingen-Schwenningen (DE)

(73) Assignee: Testo SE & Co. KGaA, Lenzkirch (DE)

(21) Appl. No.: 15/782,135

(22) Filed: Oct. 12, 2017

(30) Foreign Application Priority Data
Oct. 26, 2016 (DE) 102016012903.4

(51) Int. Cl. G06F 17/40; G06K 7/01; G08B 3/10; G06F 17/30

(52) U.S. Cl. CPC G06F 17/40; G06F 17/30002; G08B 3/10; G06K 7/01

(57) ABSTRACT

A data capture system (1) having a measuring apparatus (5) for capturing measured values of a measured variable and having an announcement apparatus (7) for announcing information has a reading apparatus (4) for reading identifiers (502) and a data processing apparatus (2) for executing at least one sequential program that can be controlled by measured values of the measuring apparatus (5) and/or by identifiers (502). Reading a start identifier (503) starts an associated sequential program (601), at least one user action (604) and/or an announcement (603) is executed in the sequential program (601), and a concluded user action (604) or announcement (603) is followed by a further user action (604) or announcement (603), or the sequential program (501) is terminated (605), wherein in each user action (604) a user input is expected, the user input is buffer-stored as a user action result and the user action (604) is concluded, a user input being effected by reading an identifier (502) using the reading apparatus (4) and/or by capturing a measured variable using the measuring apparatus (5).

### INCORPORATION BY REFERENCE

The following documents are incorporated herein by reference as if fully set forth: German Patent Application No. 10 2016 012 903.4, filed Oct. 26, 2016.

### BACKGROUND

The invention is concerned with a method for data capture using data capture systems that are used in control processes and with a data capture system for using this method.

Control processes are normally used to check and document particular properties of products or production environments and to perform actions under particular conditions.

Such control processes are normally prescribed by laws or other regulations. They stimulate particular actions that need to be performed in a particular manner and/or on particular occasions.

As a result, each control process or control event has a precise stipulation of which action needs to be performed in which order.

Such a control process is used in connection with stock receipt of packaged frozen products, for example. This requires a check to be performed, at least on random samples, to determine whether a packaging for the goods is damaged and whether the temperature of the goods does not exceed a predetermined temperature. If a checked product is too warm and/or if its packaging is damaged, then it needs to be disposed of. All the measured values and other data need to be documented with reference to the controlled goods. This allows proof of compliance with the cold chain or other legal regulations to be established subsequently too.

There are further control processes in numerous variants, with not only the temperature but also other measured variables being able to be captured by a measuring instrument.

Various tools are known for the correct performance of a control process. Data capture in the aforementioned control process requires a thermometer that can be used to measure the temperature.

In addition, the temperature and any damage to a packaging need to be documented. To this end, there are control cards that include step-by-step action instructions for the actions to be performed in the control, for example. These action instructions may be available in the form of a table or of individual data sheets in paper, for example, which are manually filled in with the measured values of a measuring instrument and other information. For each product to be tested or for each control event, such a card then needs to be filled in.

Normally, the data captured in this manner are subsequently transferred from the paper to a central data memory. There, evaluation and/or further linking to produce other data or information can be effected. The transfer of the handwritten data is for the most part possible only manually, resulting in an enormous time involvement in this instance.

In order to avoid manual or other data capture of the data included on paper, the use of a computer, smartphone or tablet is also conceivable, which includes a digital representation of the table or of the data sheets, which can then be filled in on a screen. The measured values of the measuring instrument are in this case input on the screen or using a keyboard. In this way, the data are available directly in digital form and can be transferred to a data memory more easily. Subsequent data capture is no longer necessary in this case. Besides the computer or tablet, however, it is still always necessary for at least one measuring instrument to be managed, which is awkward.

Furthermore, there are numerous control processes in which use of a computer or tablet is not possible or not rational. This is the case particularly in damp, wet, hot or cold environments.

### SUMMARY

It is therefore an object of the invention to provide a method for data capture using a data capture system that simplifies the performance of such control processes, and a data capture system that can be used in all environments.

This object is achieved by a method having one or more features of the invention as well as a data capture system having one or more features of the invention.

The method according to the invention is in this case characterized particularly in that reading of a start identifier using a reading apparatus starts a sequential program associated in a data processing apparatus, at least one announcement is executed in the sequential program and an announcement or user action is followed by a further user action or announcement or the sequential program is terminated, wherein a user action awaits an input that is effected by reading an identifier using the reading apparatus or by capturing a measured value using a measuring apparatus, and the input concludes the user action.

An identifier within the meaning of the invention is a piece of machine-readable, distinguishable and evaluable information. The read process is in this case not tied to one physical principle and can be effected optically, electrically or in another manner.

Something that can be regarded as a simple optical identifier is an area that is black or white, for example, allowing two pieces of information to be optically distinguished. The reading apparatus can in this case include a simple photodiode or a photoresistor.

In order to be able to optically distinguish more than two pieces of information, barcodes, QR codes or digital paper is/are known, for example, which include information in encoded form in multiple light/dark fields. Instead of the light/dark fields, information could also be encoded by different colors. The reading apparatus used in this case may be a photosensor or a digital camera, for example.

Besides these optical identifiers, any other identifiers are also conceivable. For example, electrically encoded identifiers could thus have different electrical resistors. In this case, a reading apparatus could have two electrical contacts for passing a constant current through the identifier. The voltage dropped across the resistor can then be used for distinguishing purposes. Further identifiers may be magnetically encoded in order to be read using one or more Hall sensors.

A sequential program of the data processing apparatus may be a representation of a control process and is used for data capture on the basis of this control process. The action instructions stipulated in the control process are reflected in the user actions and announcements of the sequential program. Hence, the sequential program emulates step-by-step execution of a control process and therefore corresponds to a process card available in paper form.

The identifiers include encoded information that may be associated with different functions. By way of example, an identifier with which the starting of a sequential program is associated is referred to as a start identifier.

An identifier that is used for inputting a response is referred to as a response identifier.

In addition, the identifiers may have further associated functions.

In one development of the invention, the association of the functions with the identifiers is dynamic and/or dependent on the sequential program. In this case, the function of an identifier may also be dependent on the present execution of a sequential program. A start identifier can be considered to be a response identifier within a user action, for example. In another sequential program, a function that is independent thereof may in turn be defined. In this case, it is also possible that according to the invention, a sequential program of the data processing apparatus is now respectively associated with an identifier. Reading of a start identifier starts the execution of this associated sequential program.

The sequential program includes, according to the invention, of a sequence of user actions and/or announcements that need to be executed for a particular control process.

An announcement is a piece of information that is reproduced by the announcement apparatus. An announcement is automatically terminated after reproduction.

A user action contains an announcement of an action instruction that must be followed by a user input. Therefore, after the announcement of the action instruction, the sequential program awaits this user input until it has been effected. Alternatively, it is also possible for the absence of a user input after a waiting period to be rated as an input, so that a sequential program is terminated after a time.

The user input is effected, according to the invention, by reading a response identifier and/or by capturing a measured value using the measuring apparatus. The user input is buffer-stored as a user action result and the user action is terminated.

A terminated user action or announcement is followed by a further user action or announcement, or the sequential program is terminated.

A sequential program can be adapted to suit any control processes by stringing together multiple user actions and/or announcements for data capture.

The critical advantage in the method according to the invention is that the data capture is effected quickly and easily by identifiers and/or the capture of measured values. A keyboard or special keys or a large screen for depiction can therefore be dispensed with completely. The identifiers may be available on a paper process card, depending on the technology used, which means that, in application and ergonomics, the method according to the invention is comparable with existing manual methods using process cards.

All the user action results are already available in electronically processable form and can be stored in a data memory. Subsequent capture or digitization of the data is therefore dispensed with.

The user input is very simple and robust in the face of ambient influences as a result of the use of identifiers. The use of applicable identifiers means that the method can also be used in damp, wet, cold or hot environments. Data capture is therefore possible much more easily and efficiently.

In an expedient development of the invention, all the user action results of the sequential program are linked to one another to produce a process result.

It may be expedient if, in addition to the user action results or the process results, a piece of position information and/or details pertaining to the date and/or to the time and/or to the location of the user input and/or additional information is/are linked or stored. As a result, subsequent evaluation or association of the captured data can be effected more easily and more quickly. An additional piece of information may be a product, batch or type number, for example.

In principle, the sequence of user actions and/or announcements may be firmly prescribed in the sequential program. In this case, user actions are executed in succession, as prescribed in the underlying control process.

In addition, it is also possible for the program execution to be dynamically branched by being dependent on the result of a preceding user action. This allows a reaction to particular user action results in the program execution.

A data capture normally corresponds to an execution of a sequential program. This means that after termination of the sequential program the captured data are combined to produce a process result, as described above.

In an expedient embodiment of an invention, a data capture may alternatively consist of multiple sequential programs. A process result is available only when all the affiliated sequential programs have been executed. This data capture end can be automatically recognized as soon as all the required data are captured. This is normally the case when all the related sequential programs have been executed.

It may alternatively be expedient if reading in a conclusion identifier starts a conclusion sequential program that concludes a data capture. In this conclusion sequential program, the user action results and/or process results of the previously executed sequential programs are combined to produce an overall process result.

Furthermore, it is expedient if all the buffer-stored user action results and/or process results are transferred to a data memory. In particular, this data transfer can be effected within the conclusion sequential program.

In an advantageous development, reading in a help identifier can start a help sequential program that announces help information through the announcement apparatus. Hence, further advice on the approach or on the purpose could be announced for the sequential programs, for example.

Similarly, it is advantageous if reading in a parameter identifier allows operational parameters of a sequential program to be set.

The action instructions may be available in various forms. However, it is particularly advantageous if the announcement apparatus is configured for audibly announcing the action instructions. In this case, it is expedient if, in a configuration step, audible information is recorded that is stored as an audible announcement for an action instruction.

Furthermore, it may be advantageous if a piece of recorded audible information is linked to and/or stored with a result of a user action. This allows spoken comments on a data capture to be added, for example.

Besides the method according to the invention for data capture, the invention describes a data capture system that can be used to perform the method.

The invention additionally comprises a data capture system having a measuring apparatus for capturing measured values of a measured variable, having a reading apparatus for reading identifiers, having an announcement apparatus for announcing information, having a data processing apparatus for executing at least one sequential program that can be controlled by measured values of the measuring apparatus and/or by identifiers, and having a data memory for storing results of the sequential program.

The measuring apparatus may be a thermometer, a voltmeter, ammeter or wattmeter, a brightness sensor, a sound level meter or any other measuring instrument, for example. The measuring apparatus is therefore not restricted to the capture of a particular measured variable.

The data capture system may also have multiple different measuring apparatuses, which means that multiple measured variables can be captured.

In an advantageous embodiment of the invention, the data capture system has a temperature sensor, particularly a probe temperature sensor, as measuring apparatus. This temperature sensor allows the capture of a temperature.

A probe temperature sensor allows temperatures inside goods or products for checking to be ascertained. As such, in the case of the stock receipt control, a temperature inside the frozen goods can be captured, for example. In this manner, it is possible to establish whether the goods are consistently at the prescribed temperature.

The announcement apparatus of the data capture system is used for announcing information to the user. This information can comprise action instructions or other advice or announcements.

In an advantageous embodiment of the invention, the data capture system has, as an announcement apparatus, a loudspeaker for announcing audible information. In this manner, the user receives all announcements in audible form. The advantage of this is that the data capture system does not need any kind of visual display and can therefore be operated even without visual contact. Specifically because the user input is effected exclusively via the reading apparatus and/or the measuring apparatus, no further operator control elements are needed. The data capture system may therefore be of a very small and compact design.

The data capture system can therefore also be adapted more easily for different ambient conditions, allowing use in damp, wet, hot or cold environments without any problem.

In a further advantageous embodiment, the data capture system can have a display for visually depicting information. This visual depiction can contain the action instructions, the measured values captured by the measuring apparatus or other information, for example.

The data capture system can also have multiple dedicated visual displays, for example separate luminous displays for different states or information.

In a particularly advantageous embodiment of the invention, the data capture system has a visual display and a loudspeaker, so that announcements can be announced visually and/or audibly. In particular, the data capture system has a display for depicting the measured values of the measuring apparatus.

As already mentioned, the reading apparatus may be configured to read any identifiers.

In a particularly advantageous embodiment of the invention, the reading apparatus has an optical sensor for reading optical identifiers, particularly of barcodes, QR codes or digital paper. Optical identifiers can easily be added to the paper process cards used to date, meaning that the form and shape of the latter can be just about retained.

In this case, the use of digital paper is particularly advantageous because the identifiers used in this instance are not visible to the human eye. A paper process card equipped therewith does therefore not differ substantially from the process cards for the manual data capture used to date.

A further advantageous embodiment of a data capture system has a microphone for capturing audible information. The audible information can be used as or linked to a user action result. This would allow a spoken comment on a measured value, for example a temperature measurement, to be picked up, for example. The audible information can alternatively be interpreted and stored as a user action result, like a measured value.

In addition, it is possible for the audible information to be used as spoken action instructions for the individual sequential programs. In this manner, action instructions can be learned individually.

A data capture system according to the invention may fundamentally be united in a single device. Such a data capture system can then be operated on its own.

However, it is advantageous if the data capture system has a mobile measuring instrument and a fixed unit.

It is particularly advantageous if the mobile measuring instrument has the measuring apparatus and/or the announcement apparatus and/or the reading apparatus, and the fixed unit has the data memory and/or the data processing apparatus.

As a result, the measuring instrument may be in a small and handy configuration, so that simple handling is possible. The data memory in a fixed unit may therefore be in a large and powerful configuration, which means that adequate capacity and connection to an EDP infrastructure is easily possible. Furthermore, it is therefore a simple possibility to operate multiple mobile measuring instruments on one central data memory. In this manner, data capture can be effected using multiple mobile measuring instruments in parallel.

For the transfer of the data between the mobile measuring instrument and the fixed unit, any wired or wireless interface is on hand.

In an expedient embodiment of the invention, the fixed unit has one or more “docking stations” into which a mobile measuring instrument can be inserted, which completes a wired connection between the mobile measuring instrument and the fixed unit.

However, it is particularly expedient if the data capture system has a wireless transmission unit that can be used to interchange data between the mobile measuring instrument and the fixed unit. To this end, the mobile measuring instrument and the fixed unit preferably each have a transmission and receiving unit that can be used to set up a wireless data connection. This data connection can exist permanently, so that data can be transferred ad-hoc.

However, it is also possible, and there is also provision, for a data connection to be set up only when data needs to be transferred, particularly when a conclusion sequential program is executed or before a sequential program is terminated.

In particular, the data capture system according to the invention is configured for use in a method according to the invention as described previously.

### BRIEF DESCRIPTION OF THE DRAWINGS

The invention is explained in more detail below using an exemplary embodiment with reference to the accompanying drawings, in which:

FIG. 1 shows a block diagram with a first embodiment of a data capture system according to the invention,

FIG. 2 shows a block diagram of an embodiment of a data capture system according to the invention with a mobile measuring instrument and a fixed unit,

FIG. 3 shows a block diagram of a further embodiment of a data capture system according to the invention with a mobile measuring instrument and a fixed unit,

FIG. 4 shows an oblique depiction of a probe thermometer as a data capture system according to the invention,

FIG. 5 shows a schematic depiction of a process card with three identifiers,

FIG. 6 shows a general flowchart for a sequential program,

FIG. 7 shows a flowchart for an exemplary sequential program,

FIG. 8 shows an exemplary process card with digital paper for a control process with two different sequential programs,

FIG. 9 shows a flowchart for a first exemplary sequential program of the process card,

FIG. 10 shows a flowchart for a second exemplary sequential program of the process card, and

FIG. 11 shows a flowchart for an exemplary conclusion sequential program.

### DETAILED DESCRIPTION OF THE PREFERRED EMBODIMENTS

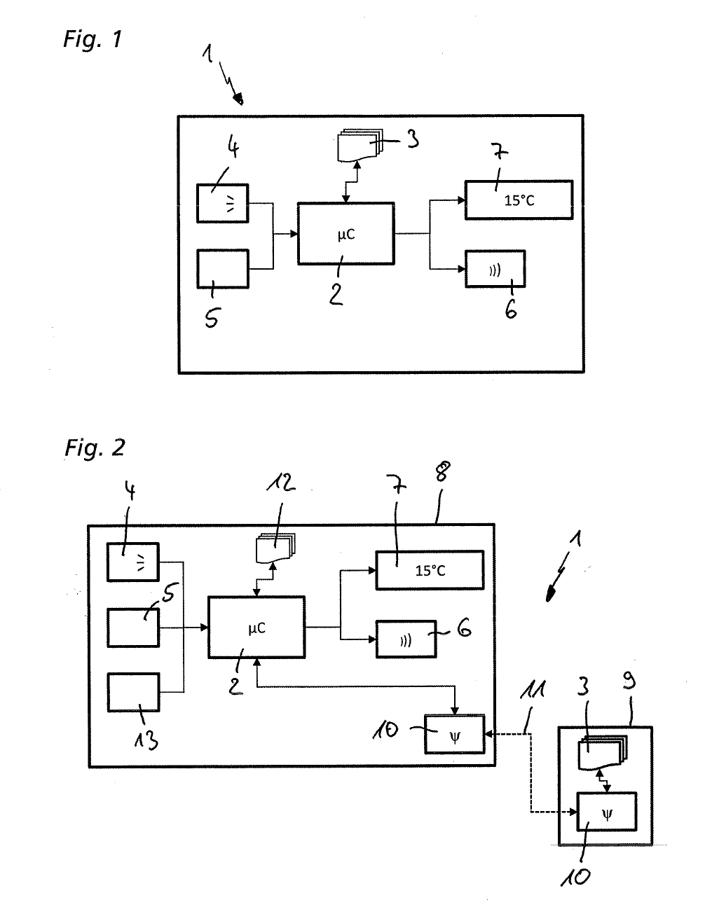

FIG. 1 shows a block diagram of a data capture system according to the invention that is denoted as a whole by 1.

The data capture system 1 has a data processing apparatus 2 that is configured to execute an operating program and various sequential programs.

In the example, the data processing apparatus 2 is configured as a microcontroller. The microcontroller is connected to a data memory 3 that can be used to buffer-store measurement data or other data of a sequential program. This data memory 3 may also be integrated in the microcontroller. The operating program and/or the sequential programs are stored in the microcontroller or in the data memory 3 or in a further separate nonvolatile memory.

For the purpose of data capture, the data capture system 1 has a reading apparatus 4 for reading identifiers. The reading apparatus 4 is connected to the data processing apparatus 2. The identifiers are used to control the execution of the sequential programs of the data processing apparatus 2 and to input data.

The data capture system 1 further has a measuring apparatus 5 for capturing measured values of a measured variable. The measured variable may be any physical variable, for example a temperature, an electrical conductivity, a brightness, a flow velocity, a voltage, a flow rate or a sound level. It is also conceivable for the data capture system 1 to have multiple measuring apparatuses for different measured variables.

The data capture system 1 has, as an announcement apparatus, a loudspeaker 6 that can be used to reproduce audible announcements. These announcements can contain spoken action instructions or signal tones, for example.

Additionally, the data capture system 1 in the example also has an optional display 7 for visually depicting announcements. In this case, a measured value captured using the measuring apparatus can be depicted, for example. This display 7 may be a graphical screen on which various announcements can be depicted universally. Additionally or alternatively, one or more discrete luminous displays may be on hand that each display only one piece of information.

In principle, one announcement apparatus is sufficient for the function according to the invention, it being irrelevant whether an audible or visual announcement apparatus is on hand. A purely audible announcement apparatus has the advantage that the data capture system 1 may be in a smaller and more compact configuration.

FIG. 2 shows an alternative embodiment of a data capture system 1 according to the invention, which substantially corresponds to the data capture system 1 of FIG. 1.

In this embodiment, however, the data capture system 1 is in a two-part configuration and has a mobile measuring instrument 8 and a fixed unit 9.

In this embodiment, the fixed unit 9 has a data memory 3 that is used to store all the captured data. The fixed unit 9 may be connected to further apparatuses for processing or depicting the data, these not being part of the data processing system 1 according to the invention, for example a computer network, however. The data memory 3 is also used as an archive that stores the data permanently or at least for a certain period, so that it is possible to resort to them at any time.

The fixed unit 9 and the mobile measuring instrument 8 each have a transmission/reception unit 10 that can be used to set up a data connection 11 via which data can be transferred. The data connection 11 is preferably wireless, but may naturally also be in a wired configuration. In this case, the data connection 11 does not have to exist permanently, but rather can preferably be set up only when data actually need to be transferred.

As a result of the division of the data memory 3 into a separate, fixed unit 9, it is possible for a mobile measuring instrument 8 to be in a much smaller and handier configuration.

In particular, it is also possible to operate multiple mobile measuring instruments 8, the data of which can all be managed centrally in the data memory 3.

In this embodiment, the data memory on hand in the mobile measuring instrument 8 is used only as a buffer store 12 for captured data up to the next data transfer and may accordingly have smaller dimensions. Data in this buffer store 12 can be erased following a data transfer to the data memory 3 of the fixed unit 8.

Furthermore, the mobile measuring instrument 8 in this embodiment has an optional microphone 13, for capturing audible information. This audible information can be stored as an input with the captured data. The microphone 13 can also be used to record audible action instructions for the sequential programs.

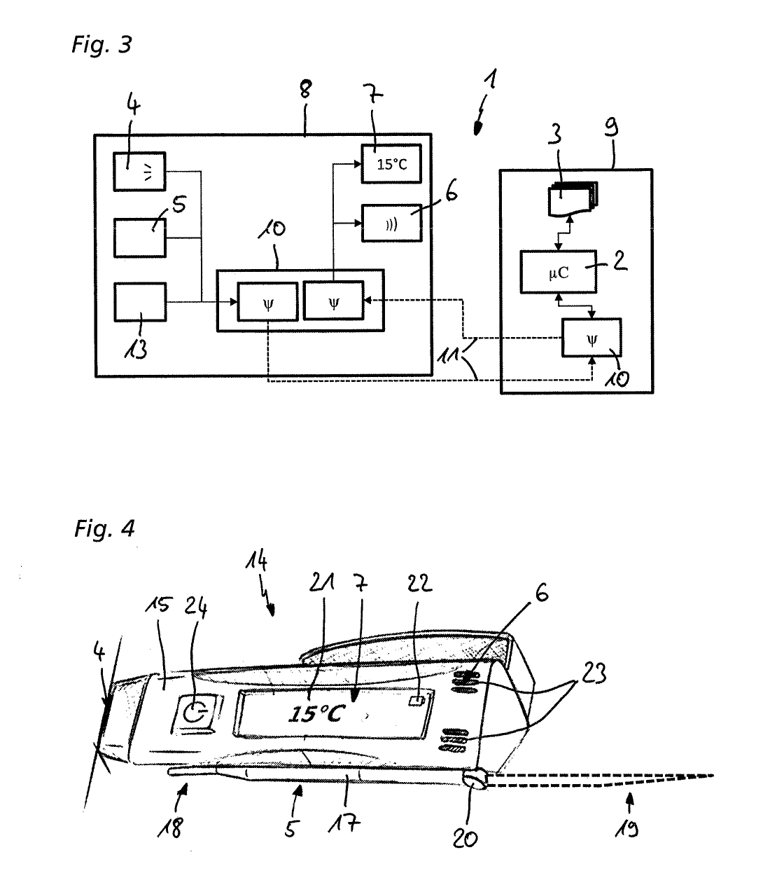

A further alternative embodiment of the invention is shown in FIG. 3. In this case too, the data capture system 1 is in a two-part configuration and has a mobile measuring instrument 8 and a fixed unit 9.

In this case, the mobile measuring instrument 8 is used merely for data capture and for depiction. For the purpose of data capture, it has a reading apparatus 4, a measuring apparatus 5 and a microphone 13, and also, as announcement apparatuses, a visual display 7 and a loudspeaker 6.

The fixed unit 9 in this case has, in addition to the fixed unit of FIG. 2, a data processing apparatus 2 that is connected to the data memory 3 and the transmission/reception unit 10.

A respective transmission/reception unit 10 can be used to set up a data connection 11 between the mobile measuring instrument 8 and the fixed unit 9. This data connection 11 is preferably wireless, but may also be wired.

The data captured by the reading apparatus 4, the measuring apparatus 5 and the microphone 13 are transferred via the data connection 11 to the data processing apparatus 2 in the fixed unit 9 and processed in a sequential program that is being executed therein. Announcements are transmitted via the data connection 11 to the mobile measuring instrument 8 and depicted therein in the display 7 or announced via the loudspeaker 6. All of the data processing is therefore effected in the fixed unit 9. For operation, a permanent and stable data connection 11 is therefore necessary.

To clarify this, FIG. 3 depicts the transmission/reception unit 10 separated into transmission unit 14 and reception unit 15.

In this embodiment, the mobile measuring instrument 8 may be in a very simple and inexpensive configuration.

Besides the exemplary embodiments shown here, other embodiments of the data capture system according to the invention are also possible. By way of example, it is conceivable that the reading apparatus and the measuring apparatus are each also arranged in separate mobile devices. In addition, it is conceivable for multiple measuring apparatuses and/or multiple announcement apparatuses to be on hand. The invention is therefore in no way restricted to the embodiments shown.

FIG. 4 shows a probe thermometer 14 as an example of a mobile measuring instrument of a data capture system 1 according to the invention as shown in FIG. 2. The probe thermometer 14 is configured as a hand-held instrument and has an approximately parallelepipedal housing 15. The housing 15 has a spring clip 16 that can be used to secure the probe thermometer 14 in a jacket pocket or on a clipboard, for example.

The probe thermometer 14 has a rod-shaped temperature sensor 17 that can be folded at a pivot 20 between a position of rest 18 and a work position 19, indicated by a dashed line in FIG. 4. In the position of rest 18, the temperature sensor 17 lies parallel against the housing 15. In a work position 19, it protrudes from the housing 15 in the longitudinal direction, so that it can be pricked or introduced into an object for testing.

Alternatively, a fixed temperature sensor would also be possible, in which case the measuring instrument would not be as compactly stowable when not in use. The temperature sensor could also be arranged retractably within the housing. When used in the food sector, however, scraps of food would then possibly get into the housing.

The probe thermometer 1 further has a display 7 in which a temperature value 21 captured by the temperature sensor 17 can be displayed. The display 17 can also depict further information, for example a battery condition 22.

Additionally, the probe thermometer 1 also has a loudspeaker for announcing audible information and action instructions. The loudspeaker is arranged inside the housing 15 and is not visible in FIG. 4. The housing 15 has multiple sound openings 23 through which the sound from the loudspeaker can get to the outside.

A switch or pushbutton switch 24 on the housing 15 can be used to switch the probe thermometer 1 on or off. Further operator control elements are not provided or necessary, since the control is effected primarily by the indicators.

To this end, the probe thermometer 1 has a reading apparatus 4 for reading optical identifiers. In the example, the reader 4 has an optical sensor that is configured to read digital paper. On digital paper, the optical identifiers are encoded in the form of dot matrices. Digital paper and the reading apparatuses therefor are sufficiently well known in the prior art and are therefore not discussed in more detail here. Instead of the digital paper, it is also possible for barcodes or QR codes to be used as optical identifiers.

In the example, the reading apparatus 3 is arranged on a narrow side of the housing 15, opposite the hinge bearing 20 of the temperature sensor 17. Naturally, other housing forms and other positions of the reading apparatus are also possible.

The probe thermometer 14 shown is designed for control processes on food, particularly for stock receipt control of packaged frozen goods. The invention is in no way restricted to this exemplary application, however.

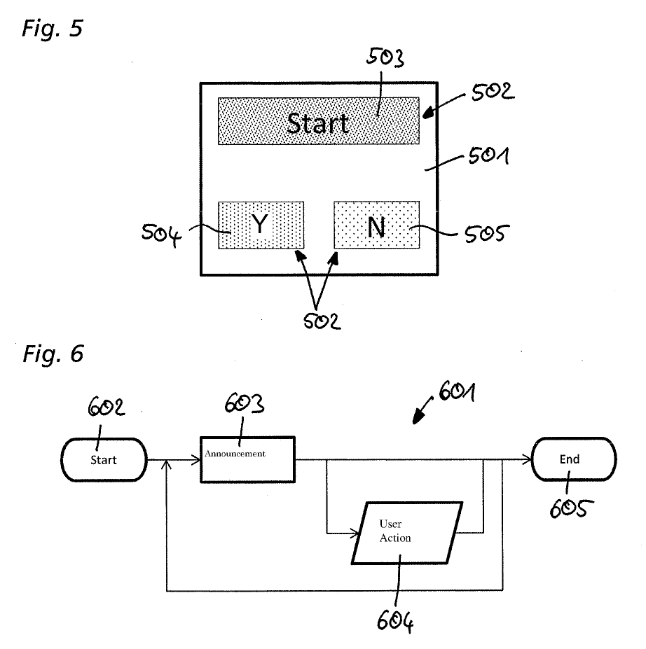

FIG. 5 shows a schematic process card 501 for an exemplary process for data capture using a data capture system 1 according to the invention, for example a probe thermometer 14 as shown in FIG. 4. The process card 501 is configured as what is known as digital paper. It has three optical identifiers 502 that each have a different encoding, these being indicated by different patterns in FIG. 5. Digital paper is sufficiently well known in the prior art, which is why further details of the encoding will not be discussed here. In principle, the type of encoding of the identifiers is also irrelevant to the invention. It would also be possible for QR codes or simple barcodes to be used as optical identifiers in this case.

The process card 501 has a start identifier 503 and, as response indicators, a YES identifier 504 and a NO identifier 505. The identifiers 502 are each linked to a function of the data processing apparatus 2. An identifier 502 is read by pointing the reading apparatus 4 at one of the identifiers 502.

The identifiers 502 on the digital paper cannot be seen by the human eye. Therefore, such a process card 501 may be of identical design to a purely manual process card.

FIG. 6 shows a general flowchart for a sequential program 601 for data capture according to the invention using a data capture system 1 according to the invention. A sequential program 601 is started by reading 602 a start identifier 503 using the reading apparatus 4. If a sequential program is already running, the data processing apparatus 2 may, by way of example, be set up such that the fresh reading of a start identifier is ignored or the sequential program currently running is aborted and the sequential program associated with the newly read start identifier is started. Other actions are also conceivable, however.

After the start, an announcement 603 is first of all executed in each sequential program 601. In an announcement 603, an announcement apparatus is used to announce an announcement, information or an action instruction. This can be effected visually or audibly, for example.

An announcement 603 can be followed by a fresh announcement 603, the sequential program 601 can be terminated 605 or a user action 604 follows.

A user action 604 expects an input that is effected by reading an identifier 502 of a process card 501 or by capturing a measured value using the measuring apparatus 5. The execution of the sequential program 601 waits until an input has been effected. Preferably, the preceding announcement 603 provides an action instruction that explains what type of input needs to be made. The input is buffer-stored as a user action result.

If no input is effected, waiting can be aborted after a predetermined period of time, for example, and a predetermined standard value can be rated as user input in order to prevent an infinite wait loop.

A user action 604 is again followed by an announcement 603 or the sequential program 601 ends 605.

In this case, all the user action results can be combined to produce a process result.

By stringing together announcements 603 and/or user actions 604 in accordance with the general flowchart, a sequential program 601 can be adapted to suit any desired process in a simple manner. The data capture can therefore be effected in a very simple manner. As a result of the input by the reading apparatus and/or the measuring apparatus, the captured data are immediately available in digital further-processable form. Subsequent, complex post-capture of the data is therefore not necessary.

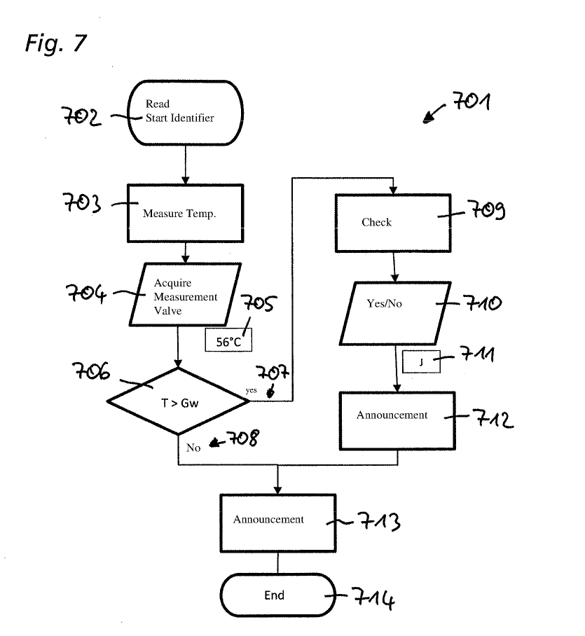

Based on a general flowchart for a sequential program 601, FIG. 7 shows a flowchart for an exemplary sequential program 701. Reading 702 a start identifier 503 starts the associated sequential program 701.

In the example, the sequential program 701 first of all has an action instruction 703 that instructs a user to measure a temperature. There follows a user action 704 that awaits the capture of a temperature. A user then needs to use the measuring apparatus 5 to measure a temperature. As soon as the measured value is available, it is buffer-stored as user action result 705.

The sequence of the announcements and user actions is firmly prescribed in a sequential program or may be dynamically dependent on at least one user action result 705.

In the example shown, the sequential program 701 has, to this end, a conditional branch 706 that is dependent on the user action result 705 of the preceding user action 704. In the example, the condition checked is whether the buffer-stored temperature measured value 705 is larger than a stipulated limit value.

If the condition is satisfied, the sequential program is branched to a YES branch 707. If not, the sequential program continues in a NO branch 708. Besides such two-fold branch operations, conditions having more than two program branches are also conceivable.

In the YES branch 707, there again follows an action instruction 709 for checking an object. There follows a user action 710, which this time expects an input by the reading apparatus 4. Reading an identifier 502 concludes this input. In this case, the identifier 502 has a particular associated value in the sequential program, which value is buffer-stored as user action result 711.

This is followed by an announcement 712, and the sequential program returns to the NO branch 708.

In the NO branch 708, there follows a further announcement 713 before the sequential program is terminated 714.

The advantage of such a data capture system according to the invention is thus that all the inputs can easily be made with a single device, and no further devices are needed.

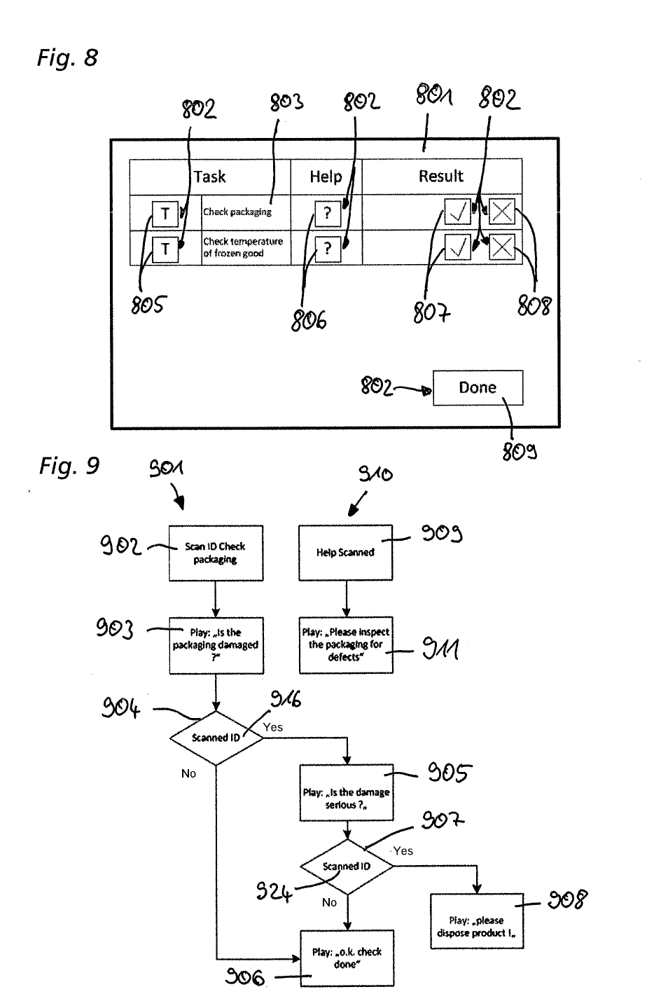

FIG. 8 now shows, by way of example, a process card 801 for a stock receipt control of packaged frozen goods. This control process first of all requires the packaging of the goods to be checked. If the packaging is in order, the temperature of the goods also needs to be measured. The result of each control step is documented and saved for later proof purposes.

This stock receipt control is performed using a probe thermometer 14 as shown in FIG. 4, for example.

The process card 801 is configured as digital paper and has multiple optical identifiers 802 that can be read by the reading apparatus 4 of a data capture system 1 according to the invention.

The data capture for this stock receipt control is split into two subprocesses. Control of the packaging 803 and control of the goods temperature 804.

The two subprocesses are printed on the process card 801 in one row of a table each.

For each subprocess, there is a start identifier 805, a help identifier 806 and, as response identifiers, a YES identifier 807 and a NO identifier 808. An identifier 802 is read by placing the reading apparatus 4 over an identifier 802.

The two start identifiers 805 each have an associated sequential program of the data processing apparatus 2.

The data processing apparatus 2 has a basic state that essentially involves waiting for an identifier 802 to be read.

If one of the start identifiers 805 is read in this basic state, the associated sequential program is started.

FIG. 9 shows the sequential program 901 for the subprocess for controlling the packaging 803. Reading 902 of the associated start identifier 805 in the basis state starts this sequential program 901. There follows a first action instruction 903 in which a user is asked to check a packaging and to indicate whether said packaging is damaged. This action instruction 903 is announced in spoken fashion via the loudspeaker 6 of the probe thermometer 14. The sequential program 901 then awaits a user input 904.

This user input 904 is now effected by reading a YES identifier 807 or NO identifier 808 of the process card 801 by the reading apparatus 4. To this end, it suffices to hold the reading apparatus 4 on an identifier 802. The result 916 of this user input 904 is buffer-stored in a data memory 12 of the probe thermometer 14.

If the result 916 of the user input 904 is “No”, a subsequent announcement 906 is used to announce that the subprocess 803 is at an end, as a result of which the sequential program 901 ends.

If the result 916 is “Yes”, however, there follows a further action instruction 905 that involves asking whether the damage is serious. The expected input 907 is in turn effected by reading a YES identifier 807 or NO identifier 808.

If the input 924 is “Yes”, a subsequent announcement 908 is used to announce that the goods need to be disposed of, or in the case of “No”, the data capture is at an end 906.

In both cases, the sequential program 901 ends. The individual user results are stored in a linked manner. To that end, it is possible for further data, for example the time, a serial number or other information, to be stored.

In addition to the start identifier 805, each subprocess of the process card 801 has a help identifier 806. Reading 909 this help identifier 806 starts a help sequential program 910. Therein, a piece of help information 911 is announced that explains the subprocess in more detail, for example precise information regarding the time from which damage is serious.

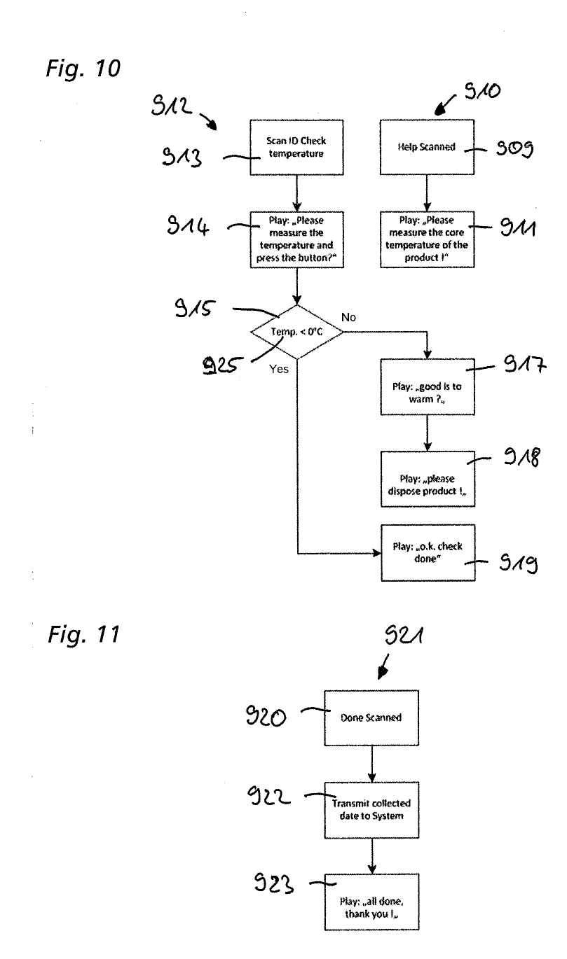

A sequential program 912 of the second subprocess for controlling the goods temperature 804 is shown in FIG. 10. Reading 913 the applicable start identifier 805 of the process card 801 starts this sequential program 912. The latter has an action instruction 914 that requests measurement of the temperature of the frozen goods. The subsequent user action 915 is now effected in this case by measuring the temperature using the measuring apparatus 5. The temperature sensor 17 of the probe thermometer 14 is, to this end, introduced into the goods and left there until the measurement has concluded. The start of the measurement can additionally be displayed by an audible or visual signal. The end of the measurement can be detected automatically, for example, as soon as the measured value does not change again. The measured value 925 captured in this manner is buffer-stored as a user result.

In a branch operation 916, a check is performed to determine whether the measured temperature 925 is above 0° C. If this is the case, there follows an announcement 917 that the goods are too warm and a further announcement 918 that the goods need to be disposed of.

If the temperature 925 is less than 0° C., there follows an announcement 919 that the measurement was ok.

In both cases, the sequential program 912 ends.

Preferably as soon as the two subprocesses of the process card 801 have been executed, the data capture for goods can be concluded. To this end, the process card 801 has a conclusion identifier 809 that starts a conclusion sequential program 921 through a reading 920.

This conclusion sequential program 921 is depicted in FIG. 8. It uses the transmission/reception device 10 to set up a data connection 11 to a fixed unit 9 and transfers 922 the process results of the two subprocesses with reference to the goods. To conclude, an announcement 54 is played indicating that the transfer has been made.

A data capture system 1 having a measuring apparatus 5 for capturing measured values of a measured variable and having an announcement apparatus 7 for announcing information has a reading apparatus 4 for reading identifiers 502 and a data processing apparatus 2 for executing at least one sequential program 501 that can be controlled by measured values of the measuring apparatus 5 and/or by identifiers 502. Reading a start identifier 503 starts an associated sequential program 601, at least one user action 604 and/or an announcement 603 is executed in the sequential program 601, and a concluded user action 604 or announcement 603 is followed by a further user action 604 or announcement 603, or the sequential program 501 is terminated 605, wherein in each user action 604 a user input is expected, the user input is buffer-stored as a user action result and the user action 604 is concluded, a user input being effected by reading an identifier 502 using the reading apparatus 4 and/or by capturing a measured variable using the measuring apparatus 5.

### LIST OF REFERENCE SYMBOLS

1 Data capture system
2 Data processing apparatus
3 Data memory
4 Reading apparatus
5 Measuring apparatus
6 Loudspeaker
7 Display
8 Mobile measuring instrument
9 Fixed unit
10 Transmission/reception unit
11 Data connection
12 Buffer store
13 Microphone
14 Probe thermometer
15 Housing
16 Spring clip
17 Temperature sensor
18 Position of rest
19 Work position
20 Pivot
21 Temperature value
22 Battery display
23 Sound opening
24 On/off switch
501 Process card
502 Identifier
503 Start identifier
504 Yes identifier
505 No identifier
601 Sequential program
602 Start
603 Announcement
604 User action
605 End
701 Sequential program
702 Start
703 Action instruction “Measure temp.”
704 User action “Measure temp.”
705 Temperature value result
706 Branch operation
707 Yes branch
708 No branch
709 Action instruction “Check”
710 User action “Read”
711 Result
712 Announcement
713 Announcement
714 End
801 Process card
802 Identifier
803 Control of the packaging
804 Control of the goods temperature
805 Start identifier
806 Help identifier
807 Yes identifier
808 No identifier
809 Conclusion identifier
901 Sequential program “Check packaging”
902 Start
903 Action instruction “Check”
904 User action “Check”
905 User action “Damage”
906 Announcement “End”
907 Action instruction “Damage”
908 Announcement “Dispose of”
909 Start
910 Help sequential program
911 Help information
912 Sequential program “Check temp.”
913 Start
914 Action instruction “Measure temp.”
915 User action “Measure temp.”
916 Result
917 Announcement “Too warm”
918 Announcement “Dispose of”
919 Announcement “Ok”
920 Start
921 Conclusion sequential program
922 Data transfer
923 Announcement “Ok”
924 Result
925 Temperature measured value

1. A method for data capture using a data capture system (1), comprising reading (602; 702; 902; 909; 920) a start identifier (503; 805) using a reading apparatus (4) and starting a sequential program (601; 701; 901; 912) associated in a data processing apparatus (2), executing at least one announcement (603; 703, 709, 712, 713, 714; 903, 906, 907, 908; 914, 917, 918, 919) in the sequential program (601; 701; 901; 912) and following the announcement (603; 703, 709, 712, 713, 714; 903, 906, 907, 908; 914, 917, 918, 919) or a user action (604) by a further user action (604; 704, 710; 904, 905; 915) or further announcement (603; 703, 709, 712, 713, 714; 903, 906, 907, 908; 914, 917, 918, 919) or terminating (605) the sequential program (601; 701; 901; 912), the user action (604; 704, 710; 904, 905; 915) awaits an input that is effected by reading an identifier (502; 802) using the reading apparatus (4) or by capturing a measured value using a measuring apparatus (5), and the input concludes the user action (604; 704, 710; 904, 905; 915).

2. The method as claimed in claim 1, further comprising at least one of linking all user action results (705, 711; 916; 924, 925) of the sequential program to one another to produce a process result, or linking in at least one of a piece of position information, details pertaining to a date, to a time, to a location of the user input, or additional information to user action results (705, 711; 916; 924, 925) or process results, or storing at least one of a piece of position information, details pertaining to a date, to a time, to a location of the user input, or additional information with user action results (705, 711; 916; 924, 925).

3. The method as claimed in claim 1, further comprising prescribing a sequence of at least one of user actions (604) or announcements (603) in the sequential program (601).

4. The method as claimed in claim 1, further comprising reading a conclusion identifier (809) starting a conclusion sequential program (921) that concludes a data capture, and transferring (922) all buffer-stored user action results or process results or both to a data memory.

5. The method as claimed in claim 1, further comprising reading a help identifier (806) starting a help sequential program (910) that announces help information (911) through an announcement apparatus, or reading a parameter identifier allowing operational parameters of a sequential program to be set.

6. The method as claimed in claim 1, wherein the identifier (502; 802) is available as digital paper.

7. The method as claimed in claim 1, further comprising recording a piece of audible information that is stored as an audible announcement for an action instruction, or linking the piece of audible information with, or storing the piece of audible information with a result of a user action.

8. A data capture system (1), comprising a measuring apparatus (5) for capturing measured values of a measured variable, a reading apparatus (4) for reading identifiers (502), an announcement apparatus (6, 7) for announcing information, a data processing apparatus (2) for executing at least one sequential program (601; 701; 901; 912) that can be controlled by at least one of measured values of the measuring apparatus (5) or by identifiers (502), and a data memory (3; 12) for storing results of the sequential program (601; 701; 901; 912).

9. The data capture system as claimed in claim 8, wherein the measuring apparatus (5) includes a temperature sensor (17).

10. The data capture system as claimed in claim 8, wherein the announcement apparatus comprises at least one of a loudspeaker (6) for announcing audible information or a display (6) for visually depicting information.

11. The data capture system as claimed in claim 8, wherein the reading apparatus (4) includes an optical sensor for reading optical identifiers.

12. The data capture system as claimed in claim 8, wherein the data capture system (1) includes a microphone (13) for capturing audible information.

13. The data capture system as claimed in claim 8, further comprising a mobile measuring instrument (8) and a fixed unit (9), the mobile measuring instrument (8) has at least one of the measuring apparatus (5), the announcement apparatus (6, 7), a reading apparatus (4), and the fixed unit (9) has at least one of the data memory (3) or the data processing apparatus (2).

14. The data capture system as claimed in claim 13, further comprising a wireless transmission unit that is used to interchange data between the mobile measuring instrument (8) and the fixed unit (9).

15. The data capture system as claimed in claim 8, wherein the reading apparatus is configured to read (602; 702; 902; 909; 920) a start identifier (503; 805) and start a sequential program (601; 701; 901; 912) associated in the data processing apparatus (2), and execute at least one announcement (603; 703, 709, 712, 713, 714; 903, 906, 907, 908; 914, 917, 918, 919) in the sequential program (601; 701; 901; 912) and follow the announcement (603; 703, 709, 712, 713, 714; 903, 906, 907, 908; 914, 917, 918, 919) or a user action (604) by a further user action (604; 704, 710; 904, 905; 915) or further announcement (603; 703, 709, 712, 713, 714; 903, 906, 907, 908; 914, 917, 918, 919) or terminate (605) the sequential program (601; 701; 901; 912), and the user action (604; 704, 710; 904, 905; 915) awaits an input that is effected by reading an identifier (502; 802) using the reading apparatus (4) or by capturing a measured value using the measuring apparatus (5), and the input concludes the user action (604; 704, 710; 904, 905; 915).

16. The method as claimed in claim 1, wherein a sequence of at least one of user actions (604) or announcements (603) in the sequential program (601) is dependent on a user action result.
